(19) United States
(12) Patent Application Publication
(10) Pub. No.: US 2008/0181573 A1
(43) Pub. Date: Jul. 31, 2008

(54) Limited Use Media Player

(76) Inventor: Keith Lampert, Hollywood, FL (US)

Correspondence Address: LERNER GREENBERG STEMER LLP, P O BOX 2480, HOLLYWOOD, FL, 33022-2480, US

(21) Appl. No.: 12/019,322

(22) Filed: Jan. 24, 2008

Related U.S. Application Data
(60) Provisional application No. 60/897,357, filed on Jan. 25, 2007.

(51) Int. Cl. H04N 5/91

(52) U.S. Cl. 386/46

(57) ABSTRACT

A limited use media player is provided which comes preloaded with media content that is stored in memory. The preloaded media content can be accessed for a limited amount of time determined by at least one of expiration of the allotted time, depletion of the power source and/or opening of the media player case.

### CROSS-REFERENCE TO RELATED APPLICATION

The present application claims priority from co-pending provisional patent application Ser. No. 60/897,357, filed Jan. 25, 2007, and entitled LIMITED USE MEDIA PLAYER, that application being incorporated herein, by reference, in their entirety.

### BACKGROUND OF THE INVENTION

1. Field of the Invention

The invention relates to a portable media player and more particularly to a portable, limited use media player, and a system for distributing and recycling the same.

2. Description of the Related Art

Media players are known that can be loaded with digital media content by a user and played endlessly, so long as the batteries are replaced and/or recharged.

United States Patent Application Publication No. 2003/0016940 to Robbins discloses an audio-visual retrieval and playback apparatus for a single use which has a housing having a viewing screen thereon and which can be sealed and packaged having a headphone connected to the housing. Robbins additionally discloses a slot, which accepts audiovisual cards along with a pair of ports, for interfacing with another computer. In Robbins, data can be retrieved from an external database having a plurality of audio video data for download, in that a user views the collection of audio video data and selects an audio video datafile for download to a disposable player that will retain the audio video datafile for later use. Additionally, in Robbins, the datafile or storage device having the audio video datafile will be altered preventing any further playback after the single use playback is completed.

What is needed is a playback device that can replay media content for a limited period of time.

### SUMMARY OF THE INVENTION

It is accordingly an object of the invention to provide a limited use media player, which overcomes the above-mentioned disadvantages of the heretofore-known devices and methods of this general type. A limited use media player is provided which comes preloaded with media content that is stored in memory. The preloaded media content can be accessed for a limited amount of time determined by at least one of expiration of the allotted time, depletion of the power source and/or opening of the media player case.

In one particular embodiment of the present invention, media content can be enjoyed so long as the media player remains continuously powered by an internal power source. In that particular embodiment, once the internal power source is depleted or the media player case is opened, the pre-stored media content is lost.

Other features which are considered as characteristic for the invention are set forth in the appended claims.

Although the invention is illustrated and described herein as embodied in a limited use media player, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

Like reference numerals refer to like items throughout the drawing.

FIG. 1 is a perspective view of a limited use media player in accordance with one particular embodiment of the instant invention.

FIG. 2 is a schematic representation of a limited use media player in accordance with one particular embodiment of the instant invention.

FIG. 3 is a flow diagram of a method for making and distribution of a limited use media player in accordance with one particular embodiment of the instant invention.

FIG. 4 is a flow diagram of a method for recycling a limited use media player in accordance with one particular embodiment of the instant invention.

FIG. 5 is a schematic representation of a limited use media player in accordance with another particular embodiment of the instant invention.

### DESCRIPTION OF THE PREFERRED EMBODIMENTS

The Media Player

The limited use media device of a first embodiment of the instant invention is provided which comes preloaded with media content that is stored in volatile memory. Media content can be enjoyed so long as the media player remains continuously powered by an internal power source. Once the internal power source is depleted, a pre-determined/pre-alloted time has expired or the media player case is opened opened and/or tampered with, the pre-stored media content is lost.

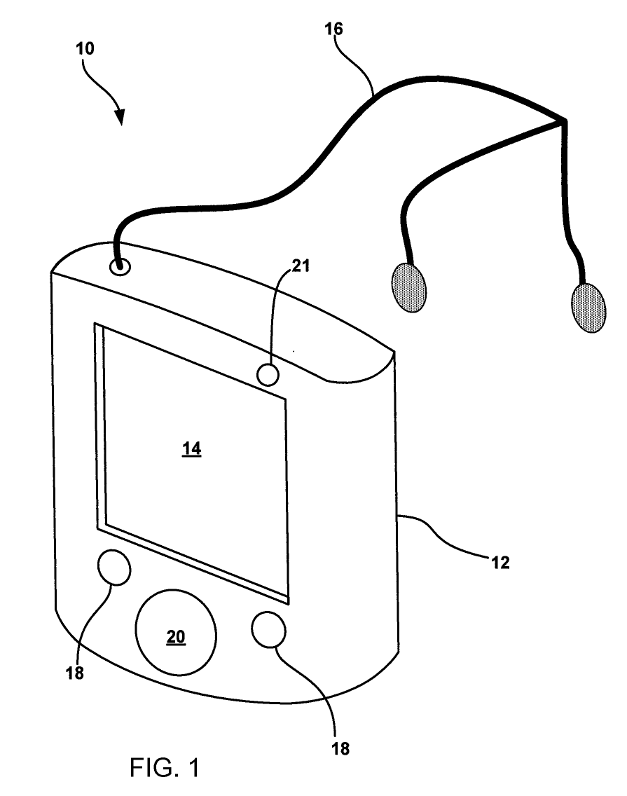

Referring now to FIG. 1, there is shown a limited use media player or device 10 in accordance with one particular embodiment of the instant invention. The limited use media device 10 includes an external housing 12, within which is stored the electronics that power the limited use media device 10. In the present preferred embodiment, the limited use media device includes a display screen 14, visible through the exterior housing 12, headphones 16, which are permanently affixed to the device 10, and a plurality of buttons 18 and/or a touch pad 20, for operating the device and/or scrolling through and selecting the content to be played. A button 21 is additionally provided to turn the device on and off.

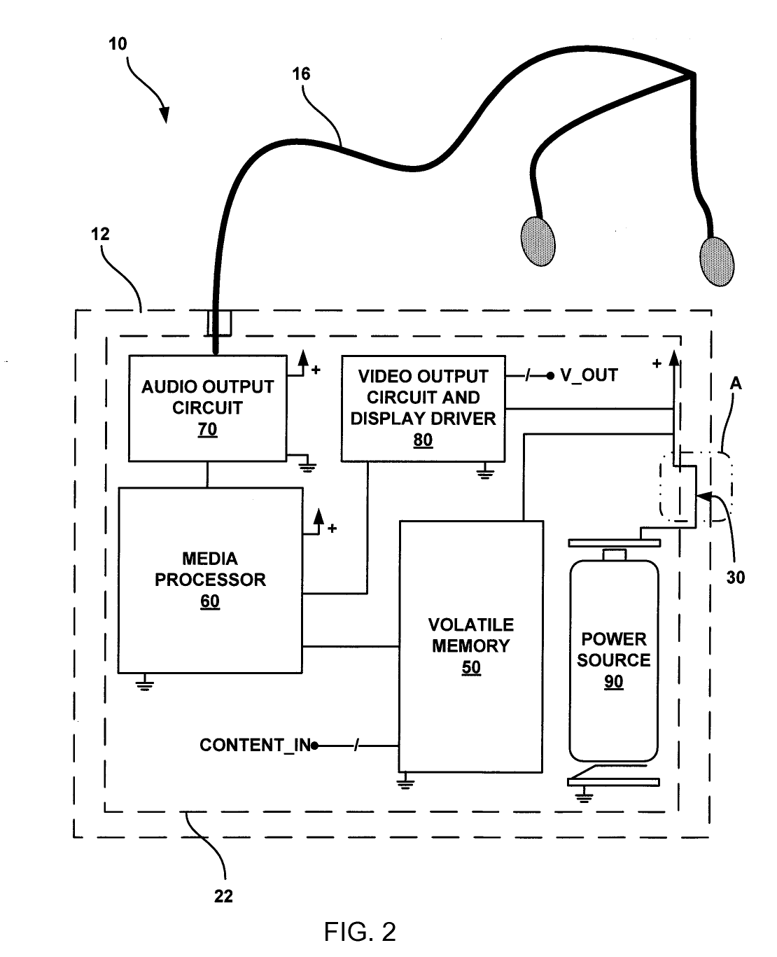

Additionally, for reasons that will be described more fully in connection with FIG. 2, the external housing 12 of the limited use media device is preferably, completely sealed, to prevent a consumer from accessing the interior of the device 10. For example, the external housing 12 can be formed as two halves molded from plastic, or another material, which halves mate together to enclose the electronics of the device 10 within the housing. The two halves of the external housing can be sealed together, as desired, using, among other alternatives, an adhesive, a heat weld, a sonic weld, or a fastener device that is highly resistant to opening.

In particular, in the present embodiment, the exterior housing 12 is sealed to prevent the consumer from accessing the electronics that provide the functionality of the media device 10, and more particularly, the memory that contains the media content and the power supply that powers the electronics. In the instant embodiment, once the housing 12 is sealed, no content can be loaded into the media player 10 from outside the media player 10.

Referring now in particular to FIGS. 1 and 2, in one particular embodiment of the instant invention, in addition to the outer housing 12, an inner housing 22 is additionally provided. The inner housing 22 contains the electronics for the media player 10, therein. The outer housing 12 provides protection for the inner housing 22, as well as isolating the inner housing 22 from access by the consumer. Like the exterior housing 12, the interior housing 22 encapsulate the internal electronics of the device 10. The display 14 may be provided outside the internal housing 22, but within the internal housing 12, if desired.

In one particular embodiment of the present invention, the outer housing can be made of a clear plastic, in order to allow graphics and/or instructions for use to be printed on an insert that is placed between the outer and inner housings 12 and 22. As will be described more fully in connection with FIG. 2, the outer and/or inner housing will additionally have a wired connection to the electronics, in order to render the content useless, in the event that the exterior housing 12 is opened or internal portions of the electronics are tampered with.

Referring more particularly now to FIG. 2, there is shown a simplified block diagram of the main functional units of a limited use media player 10 in accordance with one particular preferred embodiment of the instant invention. Such a media player 10 includes the circuitry and programming for managing and playing audio and/or video content, as is known in the art, and which will not be described, in detail, herein.

For example, the media player 10 includes a media processor 60 for processing the media content, as well as for controlling the operation of the media player device 10, according to instructions stored in ROM or EEPROM of the processor 60. Further, audio content, output by the processor 60 is further processed by the audio output circuit 70, and provided to the headphones 16 which are fixedly connected to the electronics of the media player 10, through the external housing 12.

The processor 60 additionally outputs information and instructions to the display (14 of FIG. 1), which permit the user to interact with the device, for example, to select a particular song, through on-screen displays. For example, the processor can cause to be displayed on the display, very clear and simple hierarchal menus that can be used to control the selection and playback of the media content. Such graphical information is provided by the processor 60 to a video output circuit and display driver 80, for further processing and/or display on the display (14 of FIG. 1), via the multi-bit V_OUT pin. Additionally, if the media content loaded on the media device 10 includes video, such video is further processed by the video output circuitry 80, before display on the display device 14. All of the above circuitry are powered by the power supply 90 of the present invention.

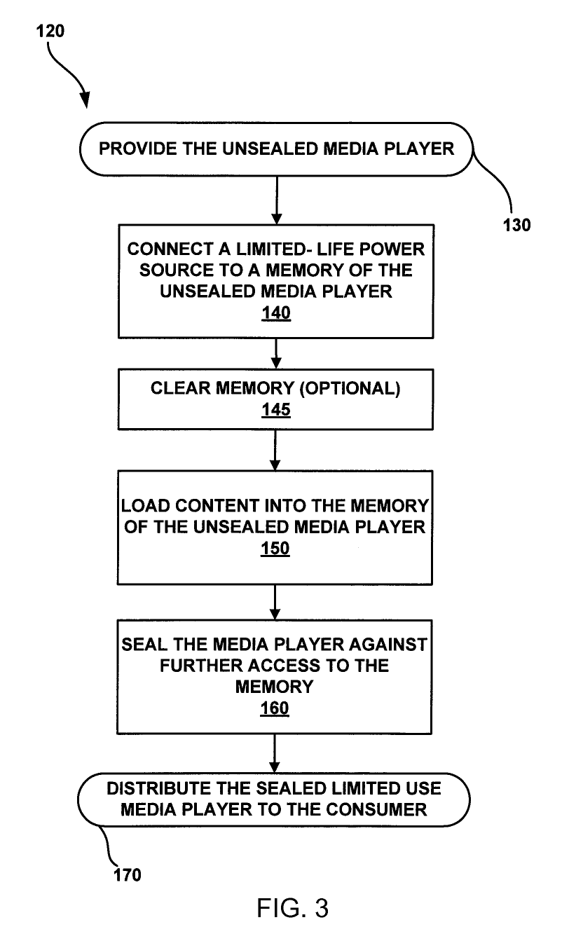

Further, to the above circuitry, the media player 10 inventively includes a volatile memory 50, in which content is preloaded in advance of being provided to a consumer. Such content is not duplicatively stored in any non-volatile memory of the device 10. The volatile memory of the instant embodiment can be any desired form of volatile, random access memory (RAM), such as DRAM, SDRAM, etc. In one particularly preferred embodiment, SDRAM is used as the volatile memory 50. The size of the volatile memory 90 can be chosen by the manufacturer/seller to hold the desired amount of media content, as will be described more fully, herebelow, in connection with FIG. 3.

The memory 50 can be loaded using a device at the manufacturer's or seller's location, which is connected directly to the volatile memory 50, via multi-bit input pins CONTENT_IN, and the content can be loaded directly to the memory 50. In the present preferred embodiment of the invention, the consumer has no access to the internal volatile memory of the media player, and as such, cannot load content into the media player, or download content from the media player. Rather, the media player 10 of the instant embodiment is configured such that media content can only be loaded to the volatile memory 90, via the input connector/pins CONTENT_IN, prior to closing and sealing the interior housing 22 of the player 10. As such, in the presently described embodiment, once the interior housing 22 is sealed, no further media content can be loaded to the volatile memory 50.

Additionally, as shown more particularly, in FIG. 2, the content on the volatile memory is maintained by a power supply or source 90. The power source 90 is used to power all of the internal electronics of the media player 10. Further, the power source 90 is used to maintain the content stored on the volatile memory 50. So long as power from the power source 90 is supplied to the volatile memory 50, the content is maintained on the volatile memory 50. However, once power to the volatile memory 50 is interrupted, even for a moment, the content stored therein is lost.

A power supply 90 is chosen, that will provide a predetermined amount of playing time of the media player 10. For example, the power supply 90, in one particular embodiment, is selected to be a battery that can power the device 10 for between 8 and 12 hours, and most preferably, 10 hours, of full operation. For example, such a media player 10 will be used intermittently by a consumer. As such, the battery, would be chosen to provide a predetermined amount of play time, despite the small draw on the battery needed to maintain the content on the volatile memory when the player is not in use. Use of the media player 10 will deplete the power supply 90. Once the power supply 90 has been depleted below a certain level necessary to operate the player, the player 10 will cease to operate. Even when not playing media, current will be drawn from the power source 90 to maintain the media content stored in the volatile memory. Eventually, the power source 90, already depleted by operation of the player 10, will become fully depleted and the media content stored in the volatile memory 50 will be lost.

In an alternate embodiment of the instant invention, the ability to replay media content stored on the device can be limited by software run by the processor 60. For example, to ensure that the user gets full, purchased and/or permitted time period for replay of the media content, a power source 90 may be chosen that will provide a time period of replay that is greater than the purchased time period. However, in the present embodiment, after the expiration of the purchased/permitted time period for replay, software in the media processor 60 can cut off the user's access and/or replay of the stored media content. The expiration of the time period can be based on a timer or clock maintained by the processor 60. Optionally, after the expiration of the purchased/permitted time period for replay, the media processor 60 could be programmed to erase the media content stored in the memory 50 of the media player device 10. In this way, a user is guaranteed to have the full, permitted time period for replay of the media content. Additionally, the ability to limit the replay time in software, is beneficial when selling different time periods for replay (i.e., two hours, four hours or ten hours), but using a standard media player (i.e., having, for example, a twelve hour power source).

Further, as shown more particularly in area “A” of FIG. 2, the electrical connection between the power supply 90 and, at least, the volatile memory 50, is directed through the interior housing 22 and fixed or otherwise rigged to a portion of the external housing 12, in such a way that opening of the external housing will break the contact and remove the power being supplied to the volatile memory 50. For example, a break away wire or removable contact 30 inserted into the electrical circuit can be connected to the outer housing in the sealing step, in such away, that opening of the outer housing removes the contact and/or breaks the wire 30, thus, removing power to the volatile memory 50 or signaling the processor to erase the content stored in non-volatile memory, if such is used.

It is intended that the media content stored on the volatile memory 50 be lost once the power source 90 is deeply depleted (i.e., can no longer maintain the content in the memory) or if the outer casing of the device is tampered with.

Further, it can be seen that an alternate embodiment of the present invention can be made, in keeping with the present invention, wherein a proprietary external connector is provided through the exterior housing, which proprietary connector connects to a proprietary mating connector at an alternate or third party location, and a secure system can be used to load content into the limited use media player at such alternate or third party location, after the device has been sealed by the manufacturer.

Yet another alternate embodiment of the present invention can be made, in keeping with the present invention, wherein external access would be allowed to the consumer through a USB connection, media card or otherwise, which would allow the consumer to download from (but not upload to) the media player, in a limited way. More particularly, an incentive may be provided to the consumer, such that, purchase of a preloaded media player could also entitle the user to “keep” (i.e., download) a predetermined number of songs or some other predetermined quantity of media content. For example, in one particular embodiment, if the media player (10 of FIG. 1) comes preloaded with 100 songs, the user may be permitted to select a lesser group of those songs (e.g., ten songs), to “keep”. The preferred songs can be selected from among those contained in the total group of songs, using a menu displayed on the display screen (14 of FIG. 1), either through a menu system or by means of an external “Favorites” button. Content, in this way, can be placed into a “favorites” folder within the memory of the media player, for later download. Alternately, the songs designated for download by the user, can be marked by an access bit, written in memory, that identifies those songs as being permissible to download. In this way, the media content selected by the user is isolated from the remaining media content in the media player's memory. Optionally, in a media player device wherein the replay time is limited by software run in the media processor (60 of FIG. 2), once the permitted time period for replay has ended, but prior to the deep depletion of the power source, the operation of the media player device may be limited only to allowing the user to select favorites to “keep”.

The download of the items designated by the user can be automatically initiated by insertion of a certain format of memory card, or connection of the device to a computer, via an interface on the media player. In one particular embodiment of the present invention, once the designated media content is downloaded outside the media player device, the memory of the media player device is erased, to prevent the remaining items from being downloaded, or the device hacked. Preferably, the memory of the media player device cannot be accessed by a computer or other device of the user, thus not permitting selective download from (i.e., downloads not automatically initiated by the media player), or any uploading to, the media player.

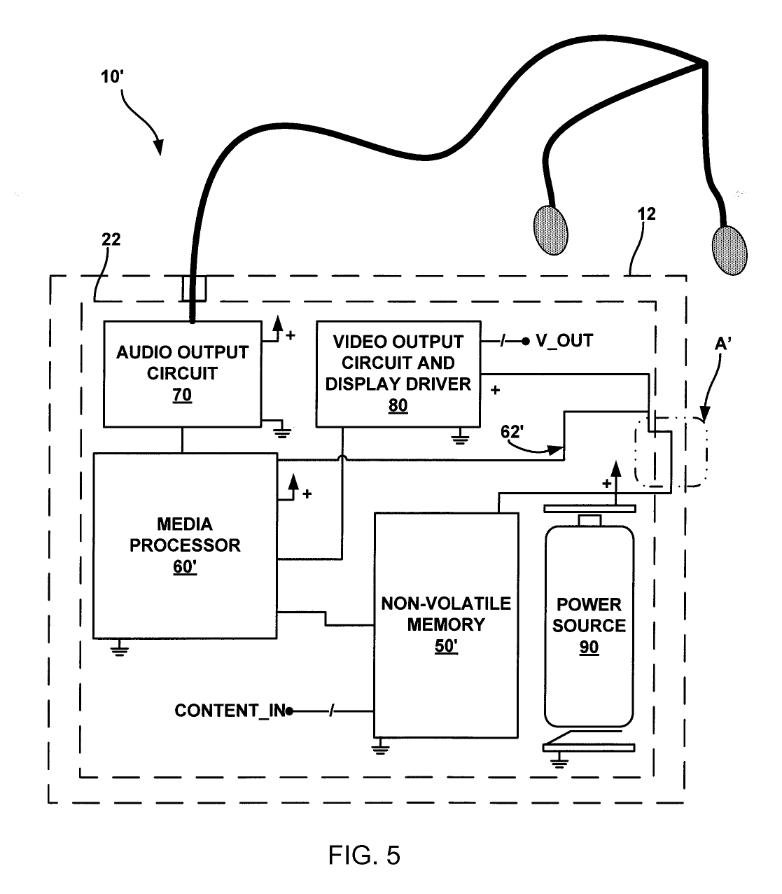

Referring now to FIG. 5, there is shown a further embodiment of a media player that can be made, in accordance with the instant embodiment. More particularly, there is shown a media player 10′ wherein, instead of including volatile memory, a non-volatile memory 50′ is provided. The non-volatile memory 50′ can be a Flash RAM, EEPROM, or other type of rewritable non-volatile memory, into which the media content can be stored.

As with the previous embodiment, in the embodiment of FIG. 5, the media content is written into the nonvolatile memory 50′, via the CONTENT_IN line, while the internal housing 22 is open. Further, in the preferred embodiment of FIG. 5, the ability to replay media content stored on the device is limited by software run by the media processor 60′. For example, software in the media processor 60′ can cut off the user's access to and/or ability to replay the stored media content upon the expiration of a permitted time period (as measured by a timer or clock maintained by the media processor 60′), and/or if the inner and/or outer housings 12, 22 are opened.

More particularly, in the particular embodiment of FIG. 5, after the expiration of the purchased/permitted time period for replay, the media processor 60′ will erase the media content stored in the memory 50′ of the media player device 10′. Further, if the media player 10′ is tampered with, the processor 60′ will erase the media content stored in the memory 50′.

More particularly, as shown more particularly in area “A′” of FIG. 5, a signal line, which runs between the power source 90 and the processor 60′, is directed through the interior housing 22 and fixed or otherwise rigged to a portion of the external housing 12, in such a way that opening of the external and/or internal housings 12, 22 will break the contact and remove the power being supplied to an input pin of the media processor 60′, via the signal line 62′ (i.e., causing the signal on line 62′ to go from high to low). In the present embodiment, power is still provided to the processor 60′ and the memory 50′, even after the housings 12, 22 are opened, to permit operation of the processor 60′ to erase the memory 50′, when the signal on the signal line 62′ switches to low (i.e., when the outer and/or inner housings 12, 22 are opened).

In yet another particular embodiment of the present invention, there may be a desire to allow the consumer to play the device longer then the life of the provided power supply. As such, a media player in accordance with the present embodiment could be provided with either a small capacitor or a small secondary power supply, which will power the volatile memory (FIG. 2) or signal line (62′ of FIG. 5), temporarily, while a fresh primary power source is swapped with the old primary power source. In this embodiment, access could be provided through the external housing and, if necessary, the internal housing, for removal and insertion of the old/new primary power source, without breaking the connection (i.e., booby-trap) rigged to the housing(s) (i.e., section A of FIG. 2; section A′ of FIG. 5).

Alternately, an extra or second power supply compartment can be provided such that an additional power supply could be added by the consumer. The second power supply compartment would be empty when provided to the consumer but filled by the consumer, once the primary power supply was close to depletion. In this configuration, the consumer would only have access, through the housing 12, to the second power supply compartment, and not to the first power supply (i.e., without breaking the booby-trapped connection through the housing). As such, once the first power supply is in deep depletion, and the second power supply is additionally deeply depleted or removed, the memory is erased. Thus, in the present arrangement, only a first additional power supply can be provided by the consumer.

Note that, in any of the above configurations and/or embodiments, the media processor that facilitates operation of the media player device can be programmed to limit access to the preloaded media content after at least one of: expiration of an allotted time period; and/or opening of the media player case, as described elsewhere, herein.

Distribution of the Media Player

Referring now to FIG. 3, there will be described a method 120 of distributing a limited use media player, such as the limited use media player 10 of FIGS. 1 and 2 and/or limited use media player 10′ of FIG. 5.

Referring now to FIGS. 1-3 and 5, the media player or device 10, 10′ is prepared for loading. Step 130. Once assembled, but prior to sealing the exterior housing, a power source, such as a battery, is connected to the volatile memory, to provide a maintenance current to that memory. Step 140. As such, in a device 10, 10′ such as in FIGS. 1, 2 and/or 5, a battery or power supply 90 is installed in the device 10, and the contact path between the power supply 90 and the memory 50, 50′, is closed. For example, a removable contact or breakable wire 30 may be inserted into a connection path between the power source 90 and the memory 50, 50′. If necessary and/or desired, and not already done, the memory 50, 50′ can be cleared at this time. Step 145.

Once powered, the memory 50, 50′ can be pre-loaded with media content. Step 150. For example, a computer or other device can be connected at the factory to the CONTENT_IN connection, and content can be loaded directly into the memory 50, 50′. In one preferred embodiment the size of the volatile memory is selected so that the media device 10, 10′ can be pre-loaded with between 50 and 100 songs. However, the media player 10, 10′ of the instant invention is not intended to be limited only to the playing of songs. For example, it is envisioned that the media player of the present invention could be sold pre-loaded with all types of media content, including: songs; audio lectures or serials, such as continuing education; an individual audio book; a plurality of music videos; an individual movie; and combinations of the above. Note that, both the memory size and the battery lifetime can be selected and tailored to the type and amount of content to be stored on a particular device. Additionally, a standard device can be developed that can generally accommodate a variety of media types, any of which can be loaded to it. For example, the same device may be loaded with 50-100 songs that are playable for 10 hours, but only one movie playable for three hours (due to the increased current draw of the processor caused by processing of the video content).

Once loaded with content, the interior and exterior housings 12, 22 are closed, and the exterior housing is sealed. Step 160. During this sealing process, the electrical path from the power supply 90 to the memory 50, 50′ is fixed to the exterior housing 22, such that, opening of the exterior housing 22 breaks the connection between the power supply 90 and the memory 50, 50′.

After sealing the media player 10, 10′, the product can be packaged and distributed in the following ways, among others. Step 170. It is envisioned that limited use media players, such as those described herein, can be sold at media outlets for price, dependent upon the content loaded therein. For example, for a price of under $10.00, a user can have access, for a limited amount of play, to new media.

It is further envisioned that limited use media players in accordance with the present invention can be pre-loaded with songs and/or music videos and/or other media and distributed through retail locations, such as bookstores, mass and discount retailers, electronics outlets, music stores, drug stores, gas stations, airports, train stations, bus stations, etc.

Additionally, media players of the present invention can be loaded with songs and/or music videos by genre, category, or type, such as Jazz, Rock, Blues, Easy Listening, etc. Alternately, media players could be sold pre-loaded with all songs of a particular artist or group.

As stated above, such a player could additionally be loaded with an individual audio book, an individual movie, or other information. For example, such a device could be pre-loaded with a museum tour, such as a tour of the Louvre, and sold in that museum's gift shop. Such a device would provide value when used by the consumer in the Louvre, but would hold little value later, once the user is removed from the described location.

Further, lectures and continuing education, such as continuing legal or medical education lectures, could be sold on a media player of the present invention or included with a course, as part of a courses tuition.

If desired, different prices could be charged for different players having different amounts of memory. For example, a first price level could be charged for a limited use media player having 50 songs, while a second price level could be charged for a media player having 100 songs.

Similarly, different price levels can be charged for media players having different battery lifetimes and/or permitted replay periods. For example, a first price level could be charged for a media player having a three hour lifetime (suitable for an airplane trip) and a second price level could be charged for a media player having a ten hour lifetime (suitable for longer period uses).

Additionally, it is envisioned that a media player, in accordance with the instant invention, could be loaded with a plurality of movies, for example, but only the ability (i.e., limited by battery lifetime or software) for replaying one movie. Such a device could be sold, for example, in airport shops or stands, giving the user a choice of movie, in advance, and the knowledge that only one of the movies can be chosen and watched to completion. Such a device could additionally include programming in the processor to lock the viewer in, to the first movie selected.

A similar concept can be used with books, wherein a plurality of books of the same genre are loaded onto the limited use media player of the instant invention, but enough time is only provided for listening to one book to completion. Once starting a book, the listener can be locked into that audio book, to ensure that a single book can be completed in the lifetime of the battery of the media player. If desired, additional time could be allotted in the planned lifetime of the power source, so that the user could sample (but not complete) the other books on the device, thus introducing the user to other books of the same genre, which the user may choose to purchase.

In addition to the normal distribution channels, it can be seen that limited use media players of the present type are ideally suited to be sold in transit stations, such as airports, train stations and bus stations. Further, such retail outlets as grocery stores, mass and discount stores, drug stores, bookstores, electronics stores, and music stores are ideally suited for distributing the present invention, wherein it can be displayed as an impulse purchase item in the check-out line.

Further, such, limited use media players as described herein, can be provided as promotional items, for free or for a reduced cost. For example, an artists new album or a series of movie previews could be pre-loaded onto such a player having an even more limited battery lifetime of, for example, one hour. In this way the consumer can sample the album and/or movie previews to determine whether to purchase the full album or DVD (either at retail or through the internet).

Note that, as described herein, the usage of the content stored on the limited use media players 10, 10′, in accordance with the present invention, is limited by time and/or tampering with the device, but not by the number of times the content is played. For example, the content stored in the memory of the limited use media device of the present invention can be replayed and/or restarted from the beginning, for the lifetime of the limited use media player (i.e., until expiration of an allotted time period, depletion of a power source and/or tampering with the sealed exterior housing).

Recycling the Media Player

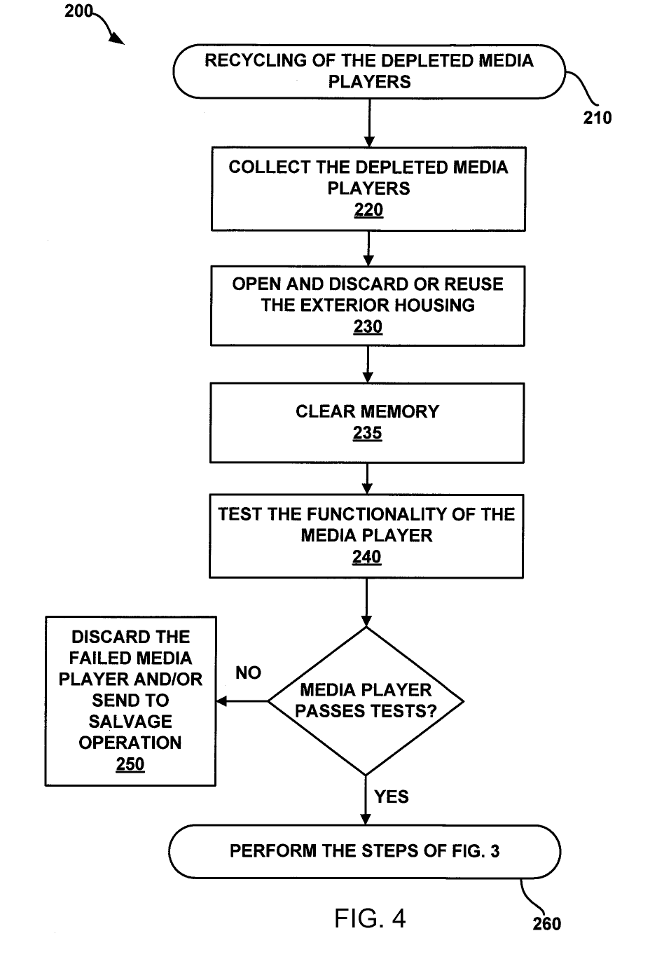

Referring now to FIG. 4, there is shown a method 200 of recycling a limited use media player (step 210), in accordance with one particular embodiment of the instant invention. Once a limited use media player, such as those described in connection with FIGS. 1-3 and 5, above, is depleted, and can no longer be used, the non-functioning media player can be collected and recycled. Step 220. In one particular embodiment of the present invention, the products are intended to be collected by means of a mail back offer, or through an arrangement with a third party collector, such as a retail chain or other party. For example, each player could be packaged with a return mailer, such that return of the player in the return mailer would entitle the consumer to a discount on the purchase of the user's next limited use media or other media content readily available in the marketplace. Once returned, a coupon or rebate could be provided to the consumer. In the embodiment wherein an insert is placed between the inner and outer housings of the product, such an insert could describe the discount or rebate and the return terms. Alternately, the consumer can return the unit to a retailer or third party participating in the collection of such devices, and be awarded an instant discount or rebate.

Once collected, the depleted limited use media player goes through a recycling process to make it ready for resale. In one particular embodiment, the outer housing of the depleted media player and any printed graphics are removed and discarded, reused and/or appropriately recycled into its component plastic and/or paper elements. Step 230.

The interior housing of the device is opened and the memory is cleared (if, somehow, not already cleared by the depletion of the unit and the opening of the exterior housing). Step 235. The functionality of the electronics portion of the player is then tested. Step 240.

Media players that fail testing are discarded and/or broken down into their component elements at the salvage operation to determine if any of those elements could be reused. Step 250.

Once the functioning of each player has been tested and approved, the formerly depleted player can be provided with a new power supply, content and packaging, in accordance with the method of FIG. 3, described above. Step 260.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. For example, it can be seen that the interior housing 22, described in connection with FIG. 2, may be omitted, if desired, without changing the scope or essence of the invention.

Therefore, it is intended that the invention not be limited to the particular embodiment disclosed as the best mode contemplated for carrying out this invention, but that the invention will include all embodiments falling within the scope of the appended claims.

I claim:

1. A limited use media player for providing access to stored media content, comprising:
a sealed exterior housing including:
a volatile memory for storing the media content; and
a power supply for continuously maintaining the media content in the volatile memory;
wherein depletion of said power supply results in the loss of said media content.

2. The limited use media player of claim 1, wherein, opening said sealed exterior housing disconnects the power supply from the volatile memory, additionally resulting in the loss of said media content.

3. A limited use media player for providing access to stored media content, comprising:
a sealed exterior housing including:
a memory for storing the media content;
a power supply for powering the device;
a connection fixed in at least a portion of said sealed exterior housing, such that opening of said sealed exterior housing breaks the connection; and
the breaking of said connection causing an inability to replay the stored media content.

4. The limited use media player of claim 3, wherein said memory is a volatile memory and said connection is an electrical connection between said power supply and said volatile memory, the breaking of said electrical connection cutting power to said volatile memory, resulting in the loss of the stored media content.

5. The limited use media player of claim 3, wherein the limited use media player additionally includes a processor located within said sealed exterior housing and said memory is a non-volatile memory, the breaking of said connection providing a signal to said processor to erase the stored media content or to otherwise disable the replay of the stored media content.

6. The limited use media player of claim 3, wherein, in the absence of said connection being broken, the replay of said stored media content is prevented after a limited amount of time.

7. The limited use media player of claim 6, wherein said limited amount of time is limited to the usable lifetime of the power supply.

8. The limited use media player of claim 7, wherein said power supply is not changeable without breaking said connection.

9. The limited use media player of claim 6, wherein the period of time is an actual quantity of time preset into the limited use media player.

10. The limited use media player of claim 9, wherein the limited use media player additionally includes a processor located within said sealed exterior housing, said quantity of time being preset in a memory accessible by said processor, said processor erasing the stored media content or otherwise disabling the replay of the stored media content upon the expiration of the preset time.

11. A limited use media player for providing access to stored media content, comprising:
a sealed exterior housing including:
a memory for storing the media content;
a power supply for powering the device;
a processor programmed to play the stored media content upon a request to do so, said processor programmed to allow unlimited replay of the stored media content for a limited amount of time.

12. The limited use media player of claim 11, wherein the limited amount of time is set by the usable lifetime of the power supply.

13. The limited use media player of claim 12, wherein said memory is a volatile memory powered by said power supply, said volatile memory being automatically erased once said power supply is depleted.

14. The limited use media player of claim 11, wherein said limited amount of time is a period of clock time preset in a memory accessible by said processor.

15. The limited use media player of claim 14, wherein upon expiration of said preset period of clock time, said processor erases the stored media content from the memory or otherwise disables the replay of the stored media content.

16. The limited use media player of claim 11, wherein said memory is a non-volatile memory.

17. The limited use media player of claim 11, wherein said memory is a volatile memory.

18. The limited use media player of claim 11, further including a connection fixed in at least a portion of said sealed exterior housing, such that opening of said sealed exterior housing breaks the connection, resulting in an inability to replay the stored media content.

19. The limited use media player of claim 18, wherein the breaking of said connection signals said processor to erase the stored media content.

20. The limited use media player of claim 18, wherein the breaking of said connection signals said processor to disable the replay of the stored media content.

21. The limited use media player of claim 18, wherein said memory is a volatile memory and the breaking of said connection removes the power supply from said volatile memory, resulting in the erasure of the stored media content.

22. A method of providing a limited use media player, comprising the steps of:
(a) providing a limited use media player in an unsealed state;
(b) loading content into the memory of the unsealed limited use media player;
(c) after the content has been loaded into memory, sealing an exterior housing of the limited use media player against further access to the memory; and
(d) distributing the sealed limited use media player.

23. The method of claim 22, further comprising the step of:
(e) recycling the sealed limited use media player.

24. The method of claim 23, wherein said recycling step comprises the steps of:
(e1) collecting a used, sealed limited used media player;
(e2) opening the sealed exterior housing of the limited use media player;
(e3) testing the functionality of the opened limited use media player; and
(e4) if the used, opened limited use media player passes the testing, performing steps (b)-(d).

25. The method of claim 24, further including the step of clearing a memory of the limited use media player between steps (e2) and (e4).

26. The method of claim 24, wherein step limited use media players that fail the testing in step (c) are stripped for usable parts.

27. The method of claim 24, wherein limited use media players that pass the testing step are reloaded with content resealed in an exterior housing and redistributed for reuse.
